(19) United States
(12) Patent Application Publication
(10) Pub. No.: US 2019/0372291 A1
(43) Pub. Date: Dec. 5, 2019

(54) TERMINAL INSERTION DEVICE AND TERMINAL INSERTION METHOD

(71) Applicant: Yazaki Corporation, Tokyo (JP)

(72) Inventors: Miyoshi MABUCHI, Makinohara-shi (JP); Nobuto TSUKIJI, Makinohara-shi (JP); Tomohiro YOSHIZAWA, Makinohara-shi (JP)

(73) Assignee: Yazaki Corporation, Tokyo (JP)

(21) Appl. No.: 16/541,807

(22) Filed: Aug. 15, 2019

Related U.S. Application Data
(63) Continuation of application No. PCT/JP2018/000267, filed on Jan. 10, 2018.

(30) Foreign Application Priority Data
Mar. 29, 2017 (JP) 2017-064558

(51) Int. Cl. H01R 43/20; H01R 12/69; H01R 43/048; H01R 4/18

(52) U.S. Cl. CPC H01R 43/20; H01R 4/183; H01R 43/048; H01R 12/69

(57) ABSTRACT

A connector terminal crimped and connected to an end of an electrical wire is inserted into a terminal housing of a connector housing while suppressing an extra length of the electrical wire. A terminal insertion device for inserting a connector terminal in a fitting part crimp-connected to an end of an internal electric wire into a cylindrical terminal housing in the connector housing holds the connector housing so that a terminal-side holding part for holding the connector terminal, a longitudinal direction of the connector terminal held by the terminal-side holding part and the axial direction of the terminal housing coincide with each other, and includes a housing moving part for sliding in the longitudinal direction the connector housing until the second fitting part of the connector terminal is accommodated in the terminal housing.

### CROSS-REFERENCE TO RELATED APPLICATIONS

This application is a Continuation of PCT International Application No. PCT/JP2018/000267, filed on Jan. 10, 2018, which claims priority under 35 U.S.C. § 119(a) to Japanese Patent Application No. 2017-064558, filed on Mar. 29, 2017. Each of the above application(s) is hereby expressly incorporated by reference, in its entirety, into the present application.

### BACKGROUND OF THE INVENTION

### Field of the Invention

The present invention relates to a terminal insertion device and a terminal insertion method for inserting a connector terminal crimp-connected to an end of an electrical wire into a cylindrical terminal housing in a connector housing.

### Description of the Related Art

Conventionally, there has been proposed a terminal insertion device for inserting a connector terminal provided at the end of an electric wire into a terminal housing of a connector housing in order to produce a connector-attached electric wire in which a connector is attached to the end of the electric wire (see Patent Literature 1 for example). In the terminal insertion machine described in Patent Literature 1, the connector terminal is held, brought close to the connector housing, and inserted into the terminal housing.

### CITATION LIST

### Patent Literature

Patent Literature 1: Japanese Patent Application Publication No. 2001-160472

### SUMMARY OF THE INVENTION

### Technical Problem

By the way, a connector may be attached to a tip of a shielded cable whose outer side is covered by a shielding member. For such a shielded cable, when using a terminal insertion device as disclosed in Patent Literature 1, an extra length of an electric wire for removing and exposing the shielding member may be longer in order to route a connector terminal at the time of terminal insertion in the vicinity of the connector housing. If such extra length becomes long, there is a possibility that the shielding effect may be reduced.

On the other hand, if the extra length of the electrical wire can be suppressed, the reduction of the shielding effect as described above can be suppressed, but it is likely to be difficult to confirm, after insertion, the presence or absence of incomplete insertion by manually checking the tension with respect to the electrical wire because of the short wire length as a lead. For this reason, it is required to increase the accuracy of the terminal insertion and suppress the occurrence of the incomplete insertion while suppressing the extra length of the electrical wire from the viewpoint of the shielding effect.

Therefore, paying attention to the problems as described above, an object of the present invention is to provide a terminal insertion device and a terminal insertion method that can insert the connector terminal crimp-connected to the end of the electrical wire into the terminal housing of the connector housing suppressing the occurrence of incomplete insertion while suppressing the extra length of the electrical wire.

### Solution to Problem

In order to solve the above-mentioned subject, a terminal insertion device of the present invention of inserting at least a portion of a housing portion of a connector terminal crimped to an end of an electrical wire into a cylindrical terminal housing in a connector housing, includes: a terminal-side holding part for holding a portion of at least one of the electrical wire and the connector terminal; a housing moving part for holding the connector housing so that a longitudinal direction of the connector terminal and an axial direction of the terminal housing coincide with each other when the portion of at least one of the electrical wire and the connector terminal is held by the terminal-side holding part and sliding the connector housing until the connector terminal is accommodated along the longitudinal direction in the terminal housing.

According to the terminal insertion device of the present invention, the connector terminal is accommodated in the terminal housing by sliding of the connector housing by the housing moving part. In other words, there is no need to move the connector terminal during accommodation, and the extra length of the electrical wire for freely routing the connector terminal when inserting the terminal in the vicinity of the connector housing becomes substantially unnecessary. Since the extra length of the electrical wire becomes substantially unnecessary, the internal electric wire can be shortened in the case where the internal electric wire to be exposed by removing and exposing the shield in the shielded cable is used as the above wire, so that reduction of the shielding effect is suppressed. That is, the terminal insertion device of the present invention is particularly effective when suppressing the reduction of the shielding effect as described above. Further, according to the terminal insertion device of the present invention, moving the connector housing, even if the connector terminal is small and the dimensional tolerance is strict, prevents the connector terminal from shaking due to vibration, so collisions of the connector housing to an entrance of the terminal housing can be suppressed.

Further, according to the terminal insertion device of the present invention, the terminal-side holding part and the housing moving part are provided, and the holding position by the terminal-side holding part and the position of a movement destination of the slide movement by the housing moving part can be managed with high precision individually. Then, such management with high accuracy allows, suppressing occurrence of incomplete insertion, the connector terminal to insert into the terminal housing of the connector housing.

As described above, according to the terminal insertion device of the present invention, while suppressing the extra length of the electric wire, the connector terminal crimp-connected to the end can be inserted into the terminal housing of the connector housing while suppressing occurrence of incomplete insertion.

Preferably, the terminal insertion device according to the present invention further includes an electrical wire holding part for holding the electric wire at a holding position opposite to the housing moving part as viewed from the terminal-side holding part, the connector terminal is a female terminal in which the housing portion is formed in a quadrangular cylindrical shape, the terminal housing accommodates the connector terminal in a non-rotatable manner around the axis, the terminal-side holding part is, when the housing moving part slides the connector housing until a terminal end of the connector terminal enters the terminal housing, configured to retract to a position at which further slide movement is not hindered while releasing the portion of at least one of the electrical wire and the connector terminal, and the housing moving part is configured to slide the connector housing until the terminal end enters the terminal housing, and further slide the connector housing until the housing portion is completely accommodated after terminal-side holding part retracts with the electric wire being held by the electrical wire holding part.

In this preferred terminal insertion device, when accommodating the housing portion of the connector terminal completely in the terminal housing, the terminal-side holding part retracts so as not to disturb sliding movement of the connector housing. At this time, according to this preferred terminal insertion device, the portion of at least one of the above-described part is held by the terminal-side holding part until the entering posture of the connector terminal is stabilized around the axis of the terminal housing by the terminal tip entering into the terminal housing, then the terminal-side holding part retracts. Thereafter, in the state where the electric wire is held by the electric wire holding part, the connector housing further slides without being blocked by the terminal-side holding part. As a result, the connector housing can smoothly slide to complete the accommodation in the state in which the entering posture of the connector terminal is stable.

Preferably, in this preferred terminal insertion device, the connector terminal further includes a housing portion, a core wire crimped portion located closer to a rear end side than the housing portion and to be crimped to the exposed core wire of the electrical wire, and a cover crimped portion located closer to the rear end side than the core wire crimped portion and to be crimped to a covered part adjacent to the exposed core wire, and the connector housing includes a quadrangularly-grooved guide rail in communication with the terminal housing to guide the terminal end to enter into the terminal housing, the terminal-side holding part holds, as the portion of at least one of the electrical wire and the connector terminal, a portion of at least one of the electric wire and the cover crimped portion, and further includes a crimp holding part setting an posture of the housing portion about an axis by holding the core wire crimped portion so that housing portion advances to the guide rail in response to sliding of the connector housing, and retract to a position at which further slide movement is not hindered while releasing the core wire crimped portion when the housing moving part slides the connector housing until the housing portion enters at least the guide rail.

In this more preferable terminal insertion device, the leading end of the terminal smoothly enters into the terminal housing by the guide rail of the connector housing, but housing portion also enters into the guide rail with the housing portion set in posture about the axis by the holding of the core crimped portion. Thus, according to this more preferable terminal insertion device, the connector housing sequentially slides from the housing portion entering to the guide rail to the terminal end entering into the terminal housing in the state in which the entering posture of the connector terminal is more stable.

In addition, in this preferred terminal insertion device, the housing moving part preferably holds the connector housing with the guide rail directed toward the housing portion, and slides the connector housing until the housing portion enters the guide rail, and the connector housing may be slid and moved until the terminal end is guided by the guide rail and enters the terminal housing after the crimp holding part retracts.

Preferably, in the terminal insertion device according to the present invention, the electrical wire is each of a plurality of internal electric wires exposed at an end of the multi-wire cable, and the connector terminal is crimped to the ends of the plurality of internal electric wires, a plurality of terminal housings which are equal to or more than the number of the plurality of internal electric wires is arranged in parallel with each other in the connector housing, and the terminal-side holding part, while directing the tip end of each of the connector terminals of the plurality of internal electrical wires toward the terminal housing, aligns the connector terminals of the plurality of internal electrical wires parallel to each other in the arrangement direction of the terminal housings.

According to this preferred terminal insertion device, in the multi-wire cable, the connector terminals of the plurality of internal electric wires, which tend to face different directions if nothing is done, are aligned in parallel to each other by the terminal-side holding part. Thus, the terminal ends of the connector terminals of the plurality of internal electric wires can be simultaneously and smoothly inserted into the terminal housing of the connector housing.

And in this preferable terminal insertion device, the plurality of internal electric wires is the pair of internal electric wires in the two-wire cable, and the standing plate extending in parallel with the axial direction of the terminal housing is erected on the shelf face parallel with the arrangement surface of the terminal housings, the standing member capable of advancing and retracting in the extending direction of the standing plate, a pair sandwiching the standing plate in the arrangement direction so as to be close to and separated from each other are provided, each includes a pair of arm members provided with an opposing surface facing the shelf surface when approaching the standing plate, and the standing plate which advanced among the portion of at least one of the electrical wire and the connector terminal of the pair of internal electric wires and the connector terminal and the pair of arm members made to approach the said standing plate hold the portion and the shelf surface and the opposing surface also hold the portion.

According to this more preferable terminal insertion device, the portion of at least one of the pair of internal electric wires and the connector terminal in the two-wire cable is held parallel to each other with high accuracy by the standing plate and the pair of arm members and by the shelf surface and the opposing surface. As a result, the terminal end of the terminal of the connector terminal by the subsequent sliding movement of the connector housing can be more smoothly inserted into the terminal housing.

Further, in order to solve the above problems, according to a terminal insertion method of the present invention is the method of inserting at least a portion of a housing portion of a connector terminal crimped to an end of an electrical wire into a cylindrical terminal housing in a connector housing, comprising the steps of: terminal-side holding step of holding a portion of at least one of the electrical wire and the connector terminal, housing moving step of holding the connector housing such that a longitudinal direction of the connector terminal and an axial direction of the terminal housing coincide with each other when the portion of at least one of the electrical wire and the connector terminal is held in the terminal-side holding step, and sliding the connector housing until the connector terminal is accommodated in the terminal housing along the longitudinal direction

According to the terminal insertion method of the present invention, as in the above-described terminal insertion device of the present invention, the extra length of the electrical wire for free routing of the connector terminal at the time of terminal insertion becomes substantially unnecessary. Since the extra length of the electrical wire becomes substantially unnecessary, the internal electric wire to be exposed is shortened and the reduction of the shielding effect is suppressed when using the inner wire of the shielded cable as the above wire, similarly to the terminal insertion device of the present invention described above. That is, the terminal insertion method of the present invention is also particularly effective when suppressing the reduction of the shielding effect. Further, even in the terminal insertion method of the present invention, since the connector terminals do not shake when the connector housing is moved, it is possible to suppress the collision of the connector housing with the entrance of the terminal housing.

Further, according to the terminal insertion method of the present invention, the holding position of the connector terminal and the position of the movement destination of the slide movement of the connector housing can be individually managed with high accuracy. Then, the connector terminal can be inserted into the terminal housing of the connector housing by such management with high accuracy, with the occurrence of incomplete insertion suppressed.

As described above, according to the terminal insertion method of the present invention, while suppressing the extra length of the electric wire, the connector terminal crimp-connected to the end is inserted into the terminal housing of the connector housing with the occurrence of incomplete insertion suppressed.

Here, only the basic form of the terminal insertion method of the present invention has been described, but various preferred embodiments of the terminal insertion device of the present invention can, needless to say, be applied to the terminal insertion method of the present invention.

### Advantageous Effects of Invention

According to the present invention, it is possible to insert, while suppressing the occurrence of the incomplete insertion, the connector terminal crimp-connected to the end of the electric wire into the terminal housing of the connector housing while suppressing the extra length of the electric wire.

### BRIEF DESCRIPTION OF DRAWINGS

FIG. 1 is a view showing a terminal insertion device according to one embodiment of the present invention;

FIG. 2 is an enlarged view showing a cable holding part shown by FIG. 1;

FIG. 3 is a schematic diagram showing a first stage of holding operation of the connector terminal by the terminal-side holding part shown by FIG. 1;

FIG. 4 is a schematic diagram showing a second stage of holding operation of the connector terminal by the terminal-side holding part shown by FIG. 1;

FIG. 5 is a schematic view showing in a further simplified manner holding operation of the connector terminal shown in FIG. 3 and FIG. 4;

FIG. 6 is a schematic diagram showing holding operation with respect to a core wire crimped portion of the connector terminal by a crimp holding part shown in FIG. 1;

FIG. 7 is a view showing a first stage of the movement of the connector housing by the housing moving part shown in FIG. 1;

FIG. 8 is a schematic view showing the movement of the connector housing shown in FIG. 7;

FIG. 9 is a view showing a second stage of the movement of the connector housing by the housing moving part shown in FIG. 1;

FIG. 10 is a schematic view showing the movement of the connector housing shown in FIG. 9;

FIG. 11 is a view showing a third stage of the movement of the connector housing by the housing moving part shown in FIG. 1;

FIG. 12 is a schematic view showing the movement of the connector housing shown in FIG. 11; and

FIG. 13 is a schematic view showing in a simplified manner a series of attaching operations of the connector terminal shown in FIG. 7 to FIG. 12 to the connector housing.

### DESCRIPTION OF EMBODIMENTS

Hereinafter, one embodiment of a terminal insertion device and a terminal insertion method of the present invention will be described.

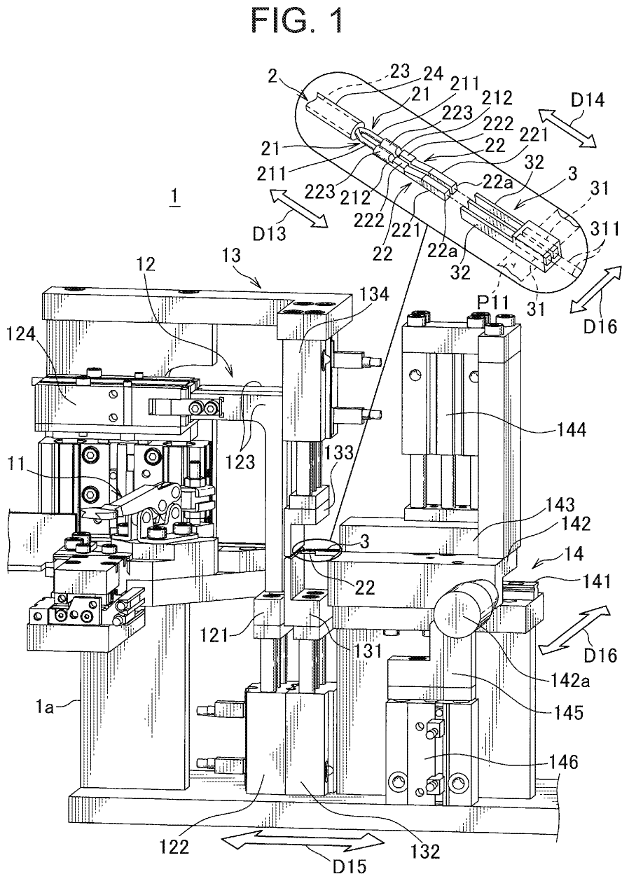

FIG. 1 is a view showing a terminal insertion device according to an embodiment of the present invention.

The terminal insertion device 1 of this embodiment inserts a connector terminal 22 crimp-connected to an end of an internal electric wire 21 of a twist shield cable 2 into a terminal housing 31 in the connector housing 3. Further, a terminal insertion method of the present embodiment is a method of inserting the connector terminal 22 into the terminal housing 31 using the terminal insertion device 1.

The twist shield cable 2 is an example of a two-wire cable of a multi-wire cable, and is a cable in which a pair of twisted inner wires 21 is covered with a shield twisted layer 23 and an outermost cover 24. At an end of the twist shield cable 2, the shield twisted layer 23 and the outermost cover 24 are removed to expose the pair of internal electric wires 21. Furthermore, the connector terminal 22 is crimped and connected to an end where a covered part 211 is removed in each internal electric wire 21 and an exposed core 212 is formed.

The connector terminal 22 is a quadrangular cylindrical female type terminal, and includes a quadrangular cylindrical fitting part 221, a core wire crimped portion 222 located on a rear end side of the fitting part 221, and a cover crimped portion 223 located on the rear end side further than the core wire crimped portion 222. The fitting part 221 is a part to be fitted to the other-side terminal, and in the present embodiment, the fitting part 221 is a housing portion for the terminal housing 31 described later. The core crimped portion 222 is a part to be crimped to the exposed core 212 at an end of the internal electric wire 21, and the cover crimped portion 223 is a cylindrical part to be crimped to the covered part 211 adjacent to the exposed core 212.

The connector housing 3 is a substantially rectangular member made of resin. In the connector housing 3, two terminal housings 31 equal in number to the internal electric wires 21 are arranged in parallel to each other. Each terminal housing 31 accommodates the rectangular cylindrical fitting part 221 of the connector terminal 22 in a non-rotatable manner around an axis 311 of the terminal housing 31, and has a rectangular cylindrical shape slightly larger than the fitting part 221. Further, the connector housing 3 is provided with a guide groove 32 in the shape of a quadrangular groove which guides an entry of the terminal end 22a of each connector terminal 22 into the terminal housing 31.

First, the terminal insertion device 1 includes a cable holding part 11 for holding the twist shield cable 2 in which the connector terminal 22 is crimped and connected to the end of the internal electric wire 21.

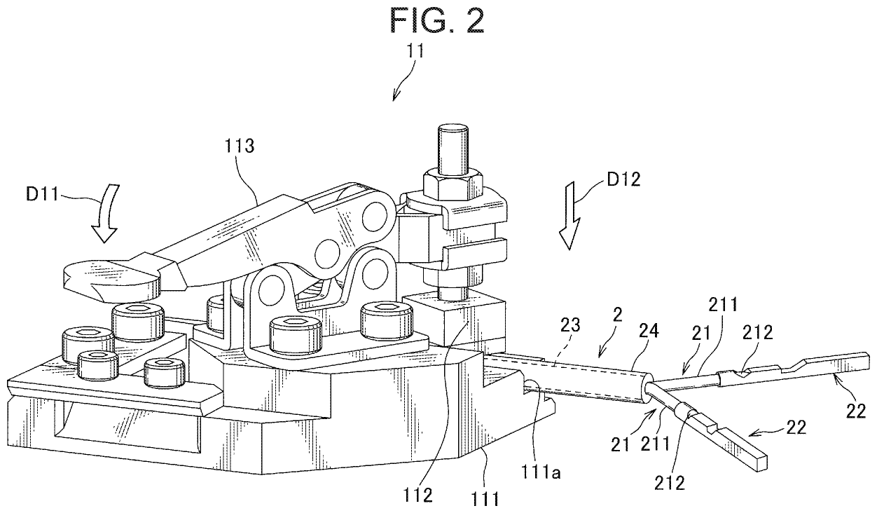

FIG. 2 is an enlarged view of the cable holding part shown in FIG. 1.

The cable holding part 11 holds the outermost cover 24 at a position away from an end where the internal electric wire 21 is exposed in the twist shield cable 2. The cable holding part 11 plays the role of an electrical wire holding part holding the inner wire 21 inside by holding the outermost cover 24. The cable holding part 11 includes a cable base 111, a cable pressing part 112, and a pressing lever 113. An upper surface of the cable base 111 is formed with a cable groove 111a in which the twist shield cable 2 is fitted. When the pressing lever 113 is pushed down in a direction of arrow D11 with the twist shield cable 2 fitted in the cable groove 111a, the cable pressing part 112 descends in the direction of arrow D12 and inserts and holds the twist shield cable 2 between the cable pressing part 112 and the cable base 111.

In the present embodiment, the cable holding part 11 is detachably attached to a frame 1a of the terminal insertion device 1. The twist shield cable 2 is held by the cable holding part 11 that is removed from the frame 1a of the terminal insertion device 1 before the internal electric wire 21 is exposed at the end. In this state, the cable holding part 11 is attached to an end part processing device of the twist shield cable 2. In this end part processing device, the outermost cover 24 and the shield twisted layer 23 are removed, the exposed core 212 is formed by removal of the covered part 211 at the end of the internal electric wire 21, and the connector terminal 22 is crimp-connected. Thereafter, the cable holding part 11 is attached to the frame 1a of the terminal insertion device 1 shown in FIG. 1 while holding the twist shield cable 2.

The terminal insertion device 1 includes a terminal-side holding part 12 for holding the connector terminal 22 of the pair of internal electric wires 21 in the twist shield cable 2 held by the cable holding part 11 as described above. Here, as will be described in detail later, in the present embodiment, the terminal-side holding part 12 holds the cover crimped portion 223 of the connector terminal 22 and the internal electric wire 21 extended therefrom. The terminal insertion device 1 is also provided with a crimp holding part 13 for holding the core crimped portion 222 of the connector terminal 22. The crimp holding part 13 will also be described in detail later together with the terminal-side holding part 12.

And the terminal insertion device 1 is provided with a housing moving part 14 which holds the connector housing 3, slides the connector housing 3 to the connector terminal 22, and inserts the connector terminal 22 in the terminal housing 31.

The cable holding part 11 described above holds the outermost cover 24 of the twist shield cable 2 at a holding position opposite to the housing moving part 14 when viewed from the terminal-side holding part 12. The cable holding part 11 is maintained to hold until the terminal insertion processing in the terminal insertion device 1 is completed.

The housing moving part 14 first holds the connector housing 3 such that a longitudinal direction D13 of the connector terminal 22 held by the terminal-side holding part 12 and an axial direction D14 of the terminal housing 31 coincide with each other. Then, the housing moving part 14 slides the connector housing 3 in a moving direction D15 along the longitudinal direction D13 until the connector terminal 22 is accommodated in the terminal housing 31, and inserts the fitting part 221 of the connector terminal 22 into the housing 31.

The housing moving part 14 includes a moving rail 141, a holding block 142, a pressing block 143, a pressing actuator 144, a movement completion confirmation block 145, and a movement completion confirmation actuator 146.

The holding block 142 is slidably held by the moving rail 141 in the moving direction D15. The holding block 142 is provided with a recess whose upper side is opened and the connector housing 3 on the terminal housing 31 side is fitted from above. The connector housing 3 fitted in the recess is held by the pressing block 143 that is moved downward in the figure by the pressing actuator 144. In addition, the holding block 142 is provided with a handle 142a that the operator holds. The operator, gripping the handle 142a, moves the holding block 142 that holds the connector housing 3 together with the pressing block 143 in the moving direction D15, and inserts the fitting part 221 of the connector terminal 22 into the terminal housing 31.

Here, in the present embodiment, the holding block 142 is moved to the left in FIG. 1 to insert the connector terminal 22. At this time, the holding block 142 is positioned above the movement completion confirmation block 145 until the fitting part 221 of the connector terminal 22 is inserted completely. In this state, even if the movement completion confirmation actuator 146 tries to raise the movement completion confirmation block 145, the movement completion confirmation block 145 cannot ascend. Only when the fitting part 221 is inserted completely and the holding block 142 is sufficiently moved to the left, the movement completion confirmation block 145 can ascend. In the present embodiment, it is confirmed that the insertion of the fitting part 221 of the connector terminal 22 is completed by the ascension of the movement completion confirmation block 145.

Next, the terminal-side holding part 12 will be described in detail. The terminal-side holding part 12 includes a standing member 121, a standing member actuator 122, a pair of arm members 123, and an arm actuator 124. The terminal-side holding part 12 holds the connector terminal 22 by the following operation of the standing member 121 and the pair of arm members 123.

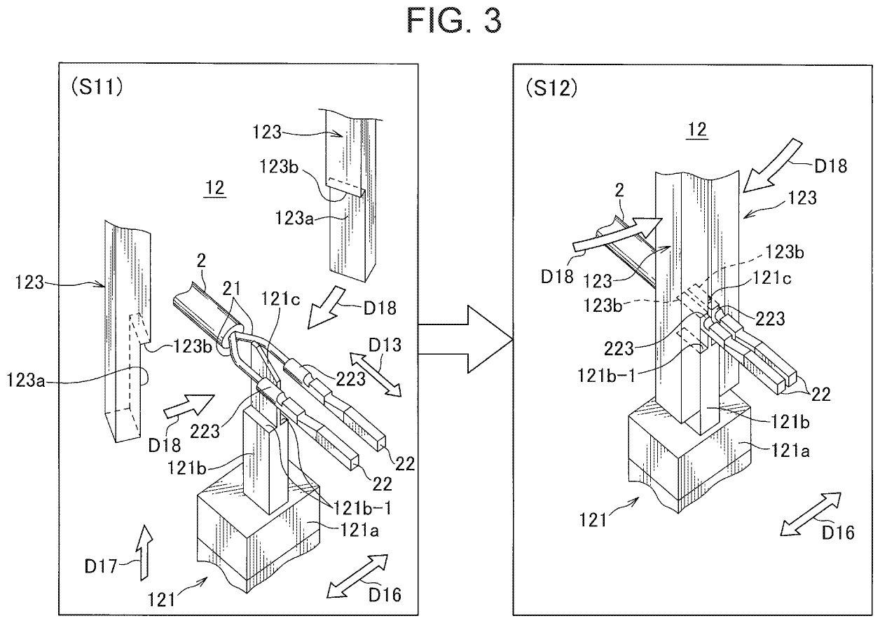

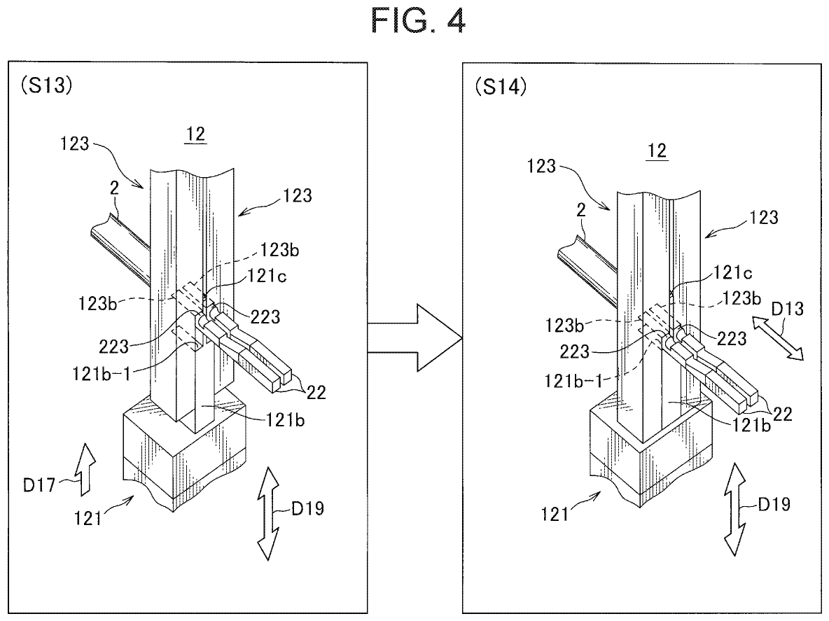

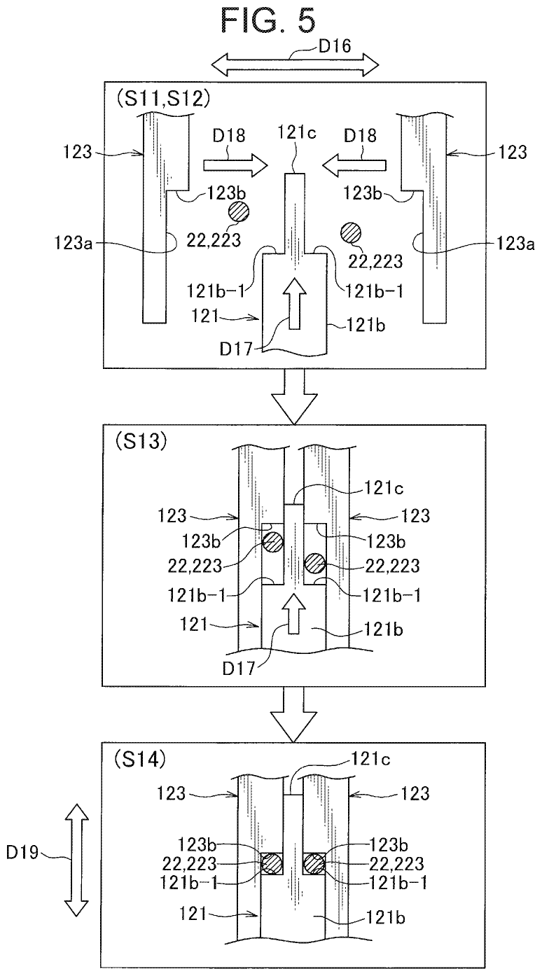

FIG. 3 is a schematic view showing a first stage of a holding operation of the connector terminal by the terminal-side holding part shown in FIG. 1, and FIG. 4 is a schematic diagram showing a second stage of holding operation of the connector terminal by the terminal-side holding part shown by FIG. 1. FIG. 5 is a schematic view showing in a further simplified manner holding operation of the connector terminal shown in FIG. 3 and FIG. 4.

The standing member 121 includes a base 121a, a quadrangular pillar-shaped columnar part 121b, and a standing plate 121c. The base 121a is attached to the standing member actuator 122 shown in FIG. 1, and the columnar part 121b is erected on the base 121a. The upper surface of the columnar part 121b is a shelf surface 121b-1 extending in parallel with an array surface P11 of the pair of terminal housings 31 shown in FIG. 1. The standing plate 121c is erected on the shelf surface 121b-1 in parallel with the axial direction D14 of the terminal housing 31. Further, the standing plate 121c is a plate having a thickness corresponding to an arrangement pitch of the pair of terminal housings 31, and an upper part has a tapered shape. The standing member 121 described above is configured to enable to advance and retreat in the vertical direction that is an extending direction of the standing plate 121c, in the terminal insertion device 1 by the standing member actuator 122.

The pair of arm members 123 is provided so as to approach to and separate from each other by sandwiching the standing plate 121c and the columnar part 121b in the arrangement direction D16 of the terminal housing 31 when the standing member 121 ascends. The approach/separation of the pair of arm members 123 is performed by rotation caused by the arm actuator 124 shown in FIG. 1. Each arm member 123 is provided with an elevated surface 123a facing the erected plate 121c and the columnar part 121b, and an opposing surface 123b of the erected member 121 against the shelf surface 121b-1 projecting from the elevated surface 123a. The opposing surface 123b faces the shelf surface 121b-1 when the arm member 123 approaches the standing plate 121c.

The holding operation of the connector terminal 22 by the terminal-side holding part 12 configured as described above will be described with reference to FIGS. 3 to 5.

In this holding operation, the standing member 121 ascends in the direction of the arrow D17, and the standing plate 121c enters between the pair of internal electric wires 21 and between the pair of connector terminals 22 (steps S11 and S12). More specifically, the standing plate 121c enters between mutual parts from the cover crimped portion 223 to the internal electric wire 21 of the connector terminal 22. At this time, since the upper part of the standing plate 121c has a tapered shape, the standing plate 121c can easily enter threrebetween. Further, in accordance with the ascension of the standing member 121, the pair of arm members 123 closes in the direction of the arrow D18 toward the standing member 121. As a result, the cover crimped portion 223 of the connector terminal 22 and the internal electric wire 21 extending from the rear end thereof are held by the arm member 123 and the standing plate 121c. At this time, the shelf surface 121b-1 of the standing member 121 and the opposing surface 123b of each arm member 123 oppose each other with the cover crimped portion 223 of the connector terminal 22 and the internal electric wire 21 interposed therebetween. However, at the stage of step S11 and step S12, a gap is opened between the opposing surface 123b and the shelf surface 121b-1, and the cover crimped portion 223 and the internal electric wire 21.

Here, in the state immediately after the cable holding part 11 is attached to the frame 1a, in many cases, the connector terminals 22 of the pair of internal electric wires 21, as shown in FIG. 2, often face in different directions in a V-shaped state. By the above-described steps S11 and S12, the pair of connector terminals 22 are aligned and held in the arrangement direction D16 of the terminal housings 31 together with the internal electric wires 21. Further, the position in the arrangement direction D16 of the terminal housing 31 of the standing plate 123c that receives the connector terminal 22 and the internal electric wire 21 being pushed by the elevated surface 123a of the arm member 123 matches a position of the terminal housing 31 in the arrangement direction D16. Further, since the standing plate 121c is a plate having a thickness corresponding to an arrangement pitch of the pair of terminal housings 31, the pair of connector terminals 22 is arranged in the arrangement direction D16 at the arrangement pitch of the pair of terminal housings 31.

Next, the standing member 121 further ascends in the direction of the arrow D17, and by the shelf surface 121b-1 of the standing member 121 and the opposing surface 123b of each arm member 123, the cover crimped portion 223 of the connector terminal 22 and the internal electric wire 21 are pinched (step S13, step S14). Thus, the cover crimped portion 223 and the internal electric wire 21 are also aligned in the vertical direction D19 orthogonal to the arrangement surface P11 of the terminal housing 31. At this time, each position in the vertical direction D19 of the shelf surface 121b-1 of the elevated member 121 which has been raised and the opposing surface 123b of the arm member 123 opposed thereto coincide with the terminal housing 31 in the vertical direction D19. As a result, the longitudinal direction D13 of the connector terminal 22 held by the terminal holding part 12 and the axial direction D14 of the terminal housing 31 coincide with each other.

The series of processes from step S11 to step S14 described above correspond to the terminal-side holding step in the terminal insertion method of the present embodiment.

Next, the crimp holding part 13 shown by FIG. 1 is demonstrated in detail. Further, the connector terminal 22 held as described above by the terminal-side holding part 12 holds the respective core wire crimped portions 222 vertically.

As described above, in the present embodiment, the cover crimped portion 223 held by the terminal-side holding part 12 in the connector terminal 22 is formed in a cylindrical shape. At this time, positioning of the terminal housing 31 and the guide rail 32 in the vertical and horizontal directions is completed by sandwiching the cover crimped portions 223 from the upper and lower sides and the left and right in the terminal-side holding part 12. On the other hand, since the cover crimped portion 223 is cylindrical, rolling thereof is not suppressed compared with that of the quadrangular cylindrical fitting part 221 around the axis 221a. For this reason, there is a possibility that the entering posture around the axis 221a to the quadrangular cylindrical terminal housing 31 or the quadrangular groove guide rail 32 is deviated from the approachable posture. Here, in the present embodiment, the core wire crimped portion 222 is formed in a shape capable of suppressing rolling around the axis 221a in the fitting part 221 by holding in the vertical direction. Although not specified here, examples of such a shape include a quadrangular cylindrical shape similar to that of the fitting part 221, and a flat shape in which the thickness direction is the vertical direction of the fitting part 221. The holding by the crimp holding part 13 suppresses rolling around the axis 221a of the fitting part 221 by holding the core wire pressure bonding part 222 in the vertical direction. As a result, the entering posture of the fitting part 221 around the axis 221a is determined to be a posture in which the terminal housing 31 and the guide rail 32 can enter.

The crimp holding part 13 includes a lower member 131, a lower member actuator 132, an upper member 133, and an upper member actuator 134. The crimp holding part 13 holds the core crimped portion 222 of the connector terminal 22 by the 2following operation of the lower member 131 and the upper member 133.

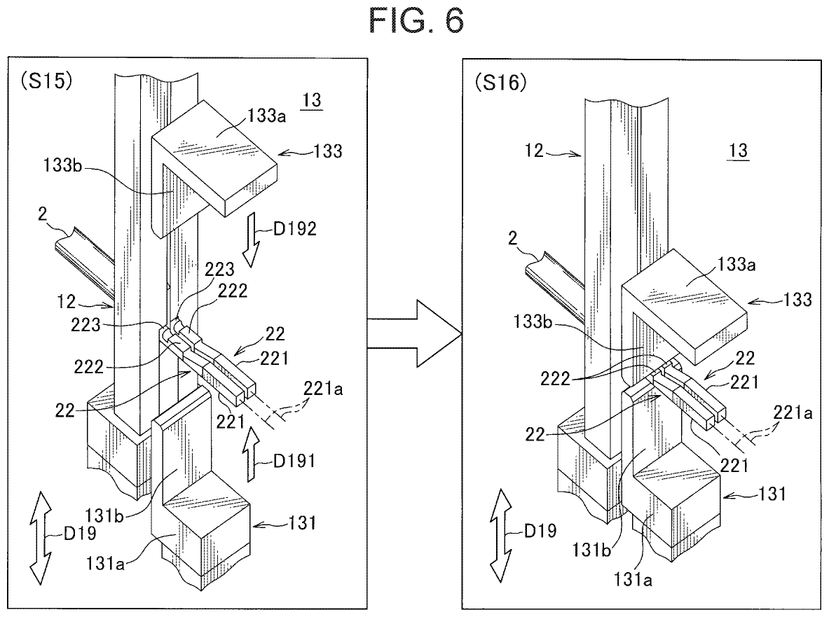

FIG. 6 is a schematic view showing a holding operation for the core wire crimped portion of the connector terminal by the crimping holding part shown in FIG. 1.

The lower member 131 includes a base 131a to be fixed to the lower member actuator 132, and an upward plate 131b extending upward from an end edge of the base 131a on the side of the terminal holding part 12.

The upper member 133 includes a base 133a to be fixed to the upper member actuator 134, and a downward plate 133b extending downward from the end edge of the base 133a on the terminal-side holding part 12 side.

In the holding operation of the core wire crimped portion 222 by the crimping holding part 13, the lower member 131 is moved by the lower member actuator 132 in the rising direction D191, and the upper member 133 is moved by the upper member actuator 134 in the descending direction D192 (step S15). Soon, an upper edge of the upward plate 131b abuts on a lower surface of the core wire crimped portion 222 of the pair of connector terminal 22, and a lower edge of the downward plate 133b abuts on an upper surface of the core wire crimped portion 222 of the pair of connector terminals 22 (step S16). Thereby, the core wire crimped portions 222 of the pair of connector terminals 22 is held in the vertical direction D19. Thus, holding the core wire crimped portion 222 in this manner suppresses rolling of the fitting part 221 of the connector terminal 22 around the axis 221a, and performs posture setting.

In the terminal insertion device 1 shown in FIG. 1, such multi-step movement is performed of the connector housing 3 by the housing moving part 14 toward the pair of connector terminals 22 held in this manner by the terminal-side holding part 12 and the crimp holding part 13.

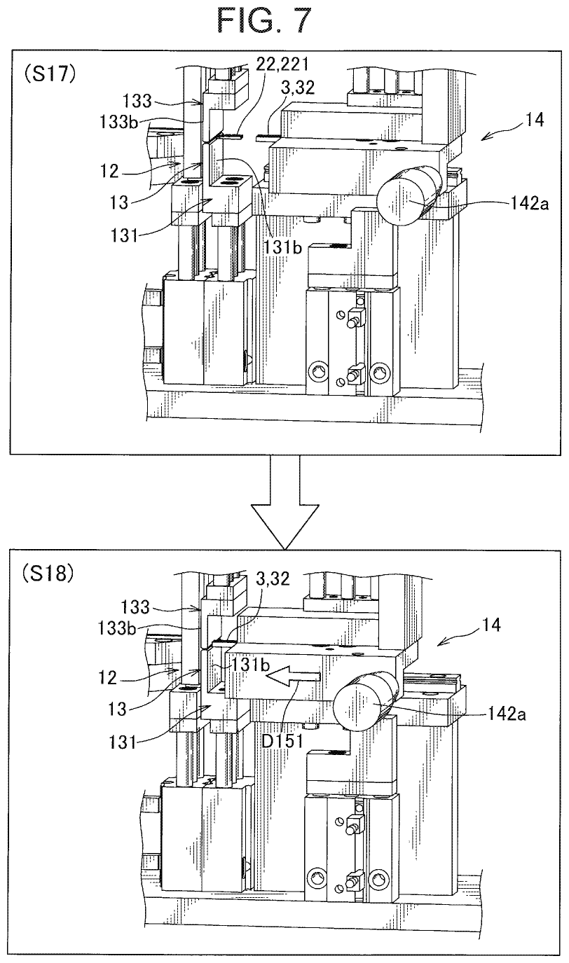

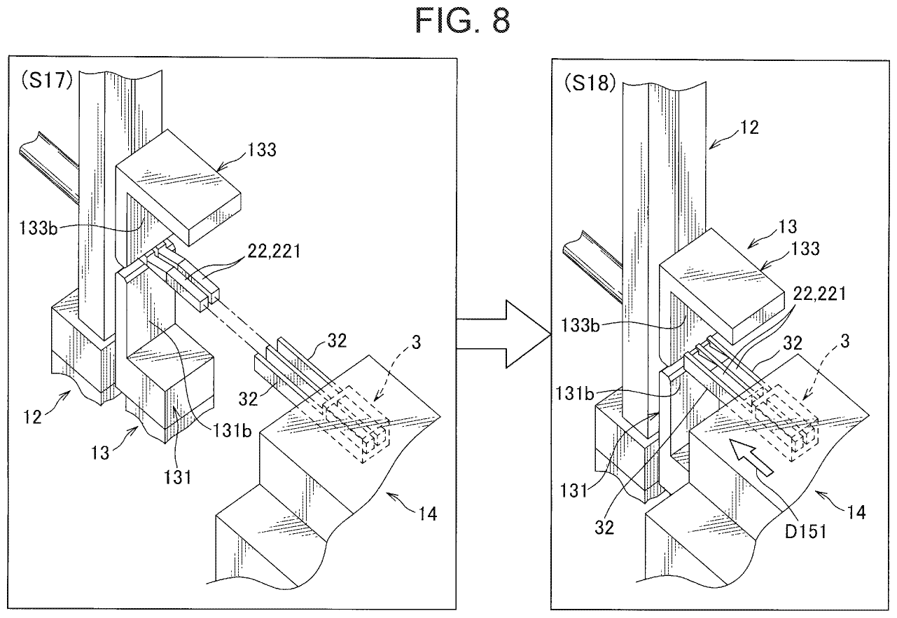

FIG. 7 is a view showing a first stage of the movement of the connector housing by the housing moving part shown in FIG. 1, and FIG. 8 is a schematic view showing the movement of the connector housing shown in FIG. 7.

The housing moving part 14 starts from the state of holding the guide rails 32 of the connector housing 3 toward the fitting part 221 of the connector terminal 22 (step S17). Then, the housing moving part 14 slides the connector housing 3 until the fitting part 221 enters the guide rail 32 (step S18). In the present embodiment, the sliding movement is performed by the operator holding the handle 142a and moving the housing moving part 14 in the insertion direction D151 of the connector terminal 22. Further, the movement at this time is performed until the leading end of the guide rail 32 abuts on the upward plate 131b of the lower member 131 and the downward plate 133b of the upper member 133 in the crimp holding part 13. At this time, the holding of the core wire crimped portion 222 of the connector terminal 22 by the crimping holding part 13 suppresses rolling around the axis 221a of the quadrangular cylindrical fitting part 221. Thereby, the quadrangular groove-shaped guide rail 32 smoothly enters.

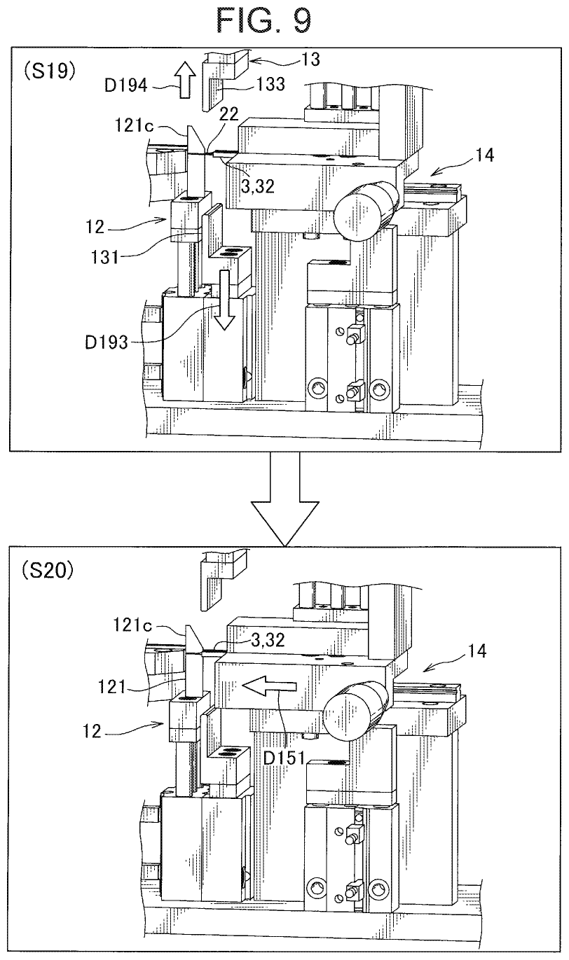

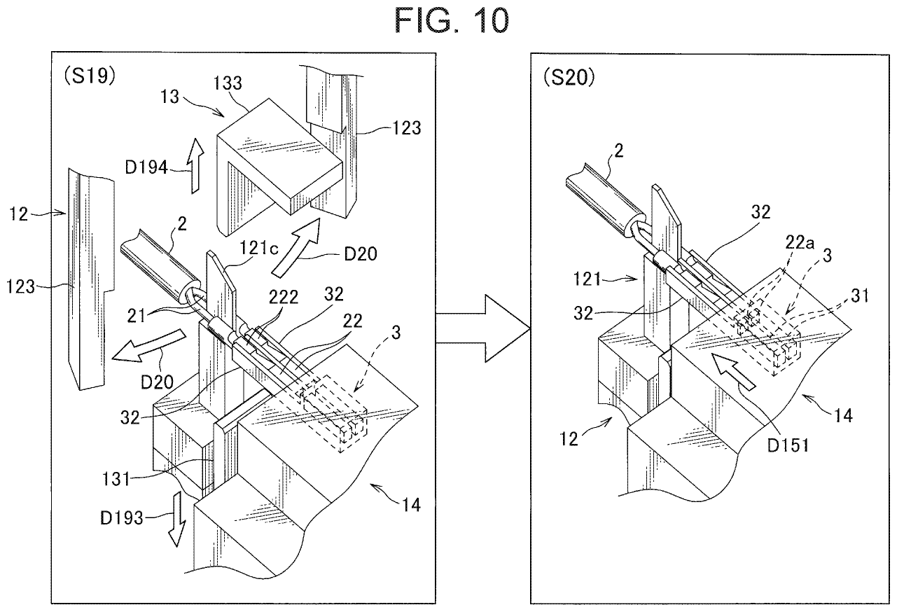

FIG. 9 is a view showing a second stage of the movement of the connector housing by the housing moving part shown in FIG. 1, and FIG. 10 is a schematic view showing the movement of the connector housing shown in FIG. 9.

In the second stage, the crimp holding part 13 retracts from the above-described holding position to a position that does not prevent further slide movement of the connector housing 3 while releasing the core wire crimped portion 222 of the connector terminal 22 (step S19). In this retraction operation, the lower member 131 is moved in the lowering direction D193, and the upper member 133 is moved in the raising direction D194. Further, in this step S19, as shown in FIG. 10, the pair of arm members 123 in the terminal-side holding part 12 also retracts. The pair of arm members 123 is opened in the direction of the arrow D20 separated from the standing plate 121c. Retraction of the arm member 123 also releases the restraint of the pair of connector terminals 22 and the internal electric wire 21 by the terminal-side holding part 12. However, at the stage of step S19, since many parts of the connector terminals 22 are in a state of entering the guide rails 32, the guide rail 32 then receives restraint, and the connector terminal 22 and the internal electric wire 21 are restricted to move.

After retracting of the crimping holder 13 and the arm member 123, the housing moving part 14 resumes sliding the connector housing 3 in the insertion direction D151 (step S20). The movement at this time is performed until the leading end of the guide rail 32 abuts on the standing member 121 of the terminal-side holding part 12. Then, sliding of the connector housing 3 in this step S20 allows the terminal end 22a of the connector terminal 22 to be guided by the guide rail 32 and to enter the terminal housing 31.

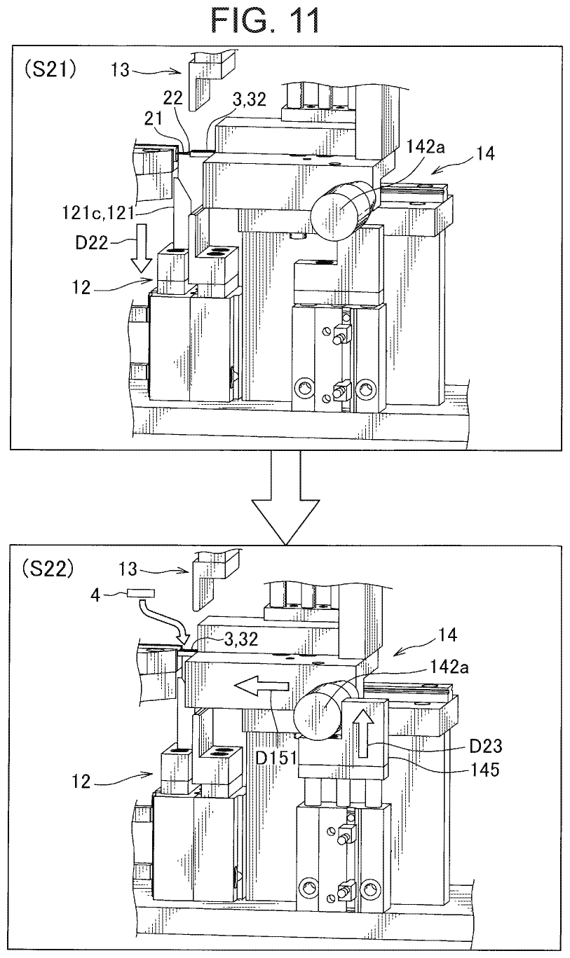

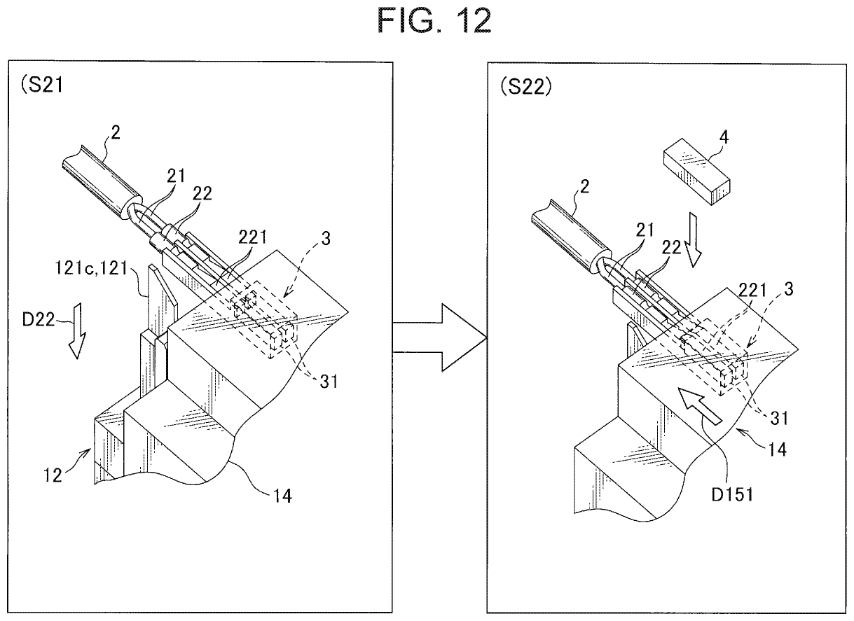

FIG. 11 is a view showing a third stage of the movement of the connector housing by the housing moving part shown in FIG. 1, and FIG. 12 is a schematic view showing the movement of the connector housing shown in FIG. 11.

At the third stage, the standing member 121 is at the rising position, and the standing plate 121c which has entered between the pair of connector terminals 22 descends in the direction of the arrow D22 and comes out of between the connector terminals 22 (step S21). By this movement, the terminal-side holding part 12 retracts to a position where all of its components do not prevent further sliding movement of the connector housing 3.

Then, after the terminal-side holding part 12 is retracted, the housing moving part 14 is moved in the insertion direction D151, and the connector housing 3 is further slid until the accommodation of the fitting part 221 as the housing portion in the connector terminal 22 is completed (Step S22). At this time, as described above, the holding of the outermost cover 24 of the twist shield cable 2 by the cable holding part 11, that is, the holding of the internal electric wire 21, is maintained. Therefore, the process of step S22 is performed in a state where the internal electric wire 21 is held by the cable holding part 11.

Here, in the present embodiment, as described above, the movement completion confirmation block 145 is provided to confirm that the fitting part 221 of the connector terminal 22 is inserted completely. The movement completion confirmation block 145 is provided to enable to ascend when the housing moving part 14 moves in the insertion direction D151 until the insertion of the fitting part 221 is completed. In step S22, after completion of the movement of the housing moving part 14, that is, after the insertion of the fitting part 221 is completed, the movement completion confirmation block 145 is moved in the upward direction D23. With the movement completion confirmation block 145 rising, it is confirmed that the insertion of the fitting part 221 of the connector terminal 22 is completed.

After completion of the insertion completion confirmation by rising of the movement completion confirmation block 145, the retainer 4 for stably restraining the pair of connector terminals 22 with its being retained in the connector housing 3 is attached to the connector housing 3 thereafter.

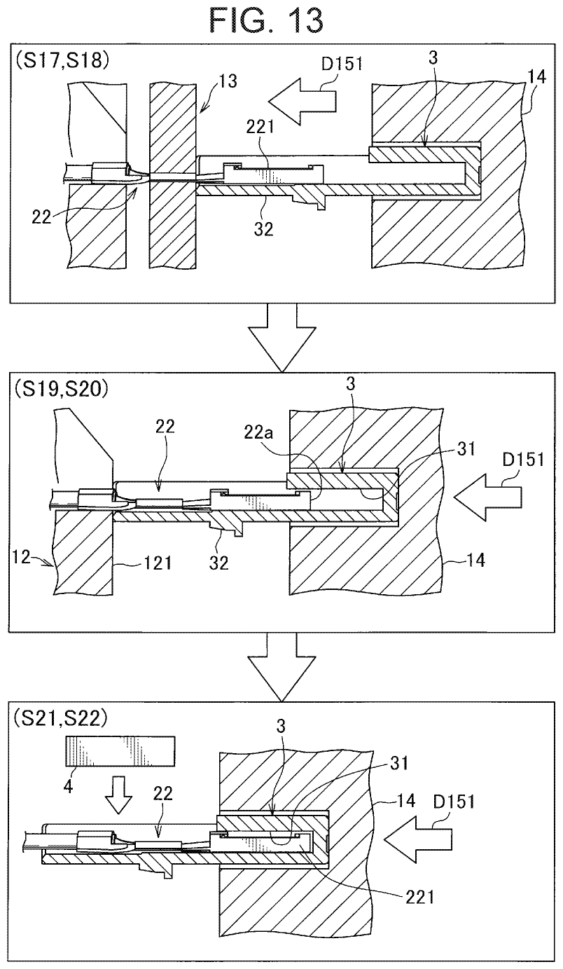

FIG. 13 is a schematic view schematically showing a series of attaching operations of the connector terminals shown in FIGS. 7 to 12 to the connector housing.

First, the connector moving part 14 is moved in the moving direction D151 by the housing moving part 14 until the tip of the guide rail 32 of the connector housing 3 abuts on the crimp holding part 13 by the operations of step S17 and step S18 as the first stage. Thus, the fitting part 221 of the connector terminal 22 enters the guide rail 32. Next, with the operations of step S19 and step S20 as the second stage, retraction of the pair of arm members 123 in the crimp holding part 13 and the terminal-side holding part 12 and further movement of the connector housing 3 in the moving direction D151 are performed. This movement is performed until the leading end of the guide rail 32 abuts on the standing member 121 of the terminal-side holding part 12, whereby the terminal leading end 22a of the connector terminal 22 enters the terminal housing 31 of the connector housing 3. Then, with the operations of step S21 and step S22 as the third stage, retraction of the standing member 121 in the terminal-side holding part 12 and further movement of the connector housing 3 in the moving direction D151 is performed. This movement is performed until the fitting part 221 as the housing portion of the connector terminal 22 is completely accommodated in the terminal housing 31. Thereafter, the retainer 4 is attached to the connector terminal 22. Finally, the connector housing 3 is removed from the housing moving part 14 to complete this series of mounting operations.

The series of processes from step S17 to step S22 described above corresponds to the housing moving step in the terminal insertion method of the present embodiment.

According to the terminal insertion device 1 and the terminal insertion method described above, the accommodation of the fitting part 221 of the connector terminal 22 in the terminal housing 31 is performed with the sliding movement of the connector housing 3 by the housing moving part 14. That is, it is not necessary to move the connector terminal 22 at the time of accommodation, and the extra length of the internal electric wire 21 for free routing of the connector terminal 22 at the time of terminal insertion in the vicinity of the connector housing 3 becomes substantially unnecessary.

Further, according to the terminal insertion device 1 and the terminal insertion method of the present embodiment, the terminal-side holding part 12 and the housing moving part 14 are provided, and the holding position by the terminal-side holding part 12 and the position of the movement destination of the movement 14 by the housing moving part can be individually managed with high precision. Then, by such management with high precision, the connector terminal 22 can be inserted into the terminal housing 31 of the connector housing 3 with the occurrence of incomplete insertion being suppressed. In this embodiment, confirmation that the sliding movement of the connector housing 3 is completed to the position where the connector terminal 22 is completely inserted into the terminal housing 31 is performed by the movement completion confirmation block 145 confirming the upward movement.

As described above, according to the terminal insertion device 1 and the terminal insertion method of the present embodiment, the connector terminal 22 crimped and connected to the end part of the internal electric wire 21 can be inserted into the terminal housing 31 of the connector housing 3 while suppressing the extra length. As a result, since the internal electric wire 21 exposed by removing the shield twisted layer 23 and the outermost cover 24 in the twist shield cable 2 can be shortened, it is possible to suppress the reduction of the shielding effect. That is, the terminal insertion device 1 and the terminal insertion method of the present embodiment are particularly effective when suppressing the reduction of the shielding effect as described above. Further, according to the terminal insertion device 1 and the terminal insertion method of the present embodiment, since the connector housing 3 is moved, vibration or the like hardly occurs on the side of the connector terminal 22 when the connector terminal 22 is inserted. For this reason, even when the connector terminal 22 is small and the dimensional tolerance is strict, the connector terminal 22 does not shake due to vibration, so that the collision of the connector housing 3 with the entrance of the terminal housing 31 can be suppressed.

Further, in the terminal insertion device 1 and the terminal insertion method of the present embodiment, in order to completely accommodate the fitting part 221 of the connector terminal 22 in the terminal housing 31, the sliding movement of the connector housing 3 obstructs in the terminal-side holding part 12 holding the connector terminal 22. In order to complete the accommodation of the fitting part 221, it is necessary to retract the terminal-side holding part 12 to a position that does not hinder the slide movement at any time. According to the terminal insertion device 1 and the terminal insertion method of the present embodiment, insertion of the terminal tip 22a into the terminal housing 31 allows the connector terminal 22 to be hold by the terminal holding part 12 until the insertion posture of the connecter terminal 22 is stabilized around the axis 311 of the terminal housing 31. Then, retraction of the terminal-side holding part 12 is performed thereafter. After that, in the state where the internal electric wire 21 is held by the cable holding part 11, the further slide movement of the connector housing 3 is performed without being blocked by the terminal-side holding part 12. Thereby, the sliding movement of the connector housing 3 can be smoothly performed in the state where the entering posture of the connector terminal 22 is stable, and the accommodation can be completed.

Further, in the terminal insertion device 1 and the terminal insertion method of the present embodiment, the terminal end 22a smoothly enters into the terminal housing 31 by the guide rail 32 of the connector housing 3. At this time, the fitting part 221 also enters into the guide rail 32 in the state in which the fitting part 221 is fixed in posture around the axis 221a held by the core wire crimped portion 222 and rolling is suppressed. According to the terminal insertion device 1 and the terminal insertion method, the connector housing 3 smoothly slides in a series from the entry of the fitting part 221 into the guide rail 32 to the entry of the terminal end 22a into the terminal housing 31 in the state where the entering posture of the connector terminal 22 is stable.

Further, according to the terminal insertion device 1 and the terminal insertion method of the present embodiment, in the twist shield cable 2, the connector terminals 22 of the pair of internal electric wires 21 that tend to face different directions if nothing is done is aligned parallel to each other by the terminal-side holding part 12. Thus, the terminal end 22a of the connector terminal 22 of the pair of internal electric wires 21 can be inserted into the terminal housing 31 of the connector housing 3 simultaneously and smoothly.

Then, according to the terminal insertion device 1 and the terminal insertion method of the present embodiment, the connector terminals 22 of the pair of internal electric wires 21 are held and aligned parallel to each other with high accuracy by clamps of the standing plate 121c and the pair of arm members 123, and the shelf surface 121b-1 and the opposing surface 123b. Thus, the terminal end 22a of the connector terminal 22 can be smoothly inserted into the terminal housing 31 by subsequent sliding of the connector housing 3.

The embodiments described above show only typical forms of the present invention, and the present invention is not limited to these embodiments. That is, various modifications can be made without departing from the scope of the present invention. As long as such modifications include the configuration of the terminal insertion device of the present invention, they are of course included in the scope of the present invention.

For example, in the embodiment described above, the pair of internal electric wires 21 of the twist shield cable 2 is illustrated as an example of the electrical wire according to the present invention. However, the electrical wire referred to in the present invention is not limited to this. The electric wire referred to in the present invention is not limited to a specific aspect such as the number, presence or absence of twist or a shield, etc., as long as the connector terminal is crimp-connected at the end.

Further, in the embodiment described above, as an example of the connector housing according to the present invention, the connector housing 3 in which the pair of terminal housings 31 provided is exemplified in which the fitting part 221 of the connector terminals 22 is accommodated. However, the connector housing according to the present invention is not limited to this. The connector housing according to the present invention may be, for example, the one provided with a terminal housing for accommodating the whole or a part of the connector terminal including the fitting part, and the number of terminal housings can also be arbitrarily set as long as it is equal to or more than the number of connector terminals to be inserted.

In the embodiment described above, the terminal insertion device 1 including the crimp holding part 13 for holding the core wire crimped portion 222 of the connector terminal 22 and the terminal insertion method performed by the terminal insertion device 1 are illustrated as an example of the terminal insertion device or the terminal insertion method according to the present invention. However, the terminal insertion device and the terminal insertion method according to the present invention are not limited to this, but a device having only a terminal crimped portion without a crimping holding part as a holding structure of a connector terminal or a method performed by such device may be used. However, as described above, providing the crimp holding part can suppress the rolling of the connector terminal and can more smoothly insert the connector terminal.

In the embodiment described above, as an example of the terminal insertion device or the terminal insertion method according to the present invention, the terminal insertion device 1 is illustrated in which a part of the operation process such as the movement of the housing moving part 14 is performed by the handle operation or the like of the operator. However, the terminal inserting apparatus and the terminal inserting method according to the present invention are not limited to this, but an apparatus in which all the work steps are automatically performed, a method performed in such an apparatus, and the like may be used.

In the embodiment described above, the housing moving part 14 and the housing moving process are illustrated as an example of the housing moving part or the housing moving step according to the present invention in which the fitting part 221 of the connector terminal 22 enters the guide rail 32 of the connector housing 3 by the movement in the first stage. At this stage, the terminal end 22a of the connector terminal 22 is still positioned in front of the terminal housing 31 in the state where the guide rail 32 abuts on the crimp holding part 13. The terminal end 22a successfully enters into the terminal housing 31 by the movement of the connector housing 3 in the subsequent second stage. However, the housing moving part and the housing moving process said to this invention are not limited to this. The housing moving part or the housing moving step according to the present invention may be such as, for example, causing the terminal end of the terminal of the connector terminal to enter at once into the terminal housing by the movement at the first stage described above.

In the embodiment described above, the terminal-side holding part 12 holding both the internal electric wire 21 and the connector terminal 22 and the terminal-side holding step are exemplified as an example of the terminal-side holding part and the terminal-side holding step according to the present invention. However, the terminal-side holding part and the terminal-side holding step according to the present invention are not limited to this, and may be, for example, to hold only an electric wire, or even hold only a connector terminal.

### REFERENCE SIGNS LIST

1 terminal insertion device
2 twist shield cable
3 connector housing
4 retainer
11 cable holding part
12 terminal side holding part
13 crimp holding part
14 housing moving part
21 internal electric wire
22 connector terminal
31 terminal housing
32 guide rail
121 vertical member
121a base
121b column shape part
121b-1 shelf surface
121c vertical plate
122 vertical member actuator
123 arm member
123a vertical surface
123b opposing surface
124 arm actuator
131 lower member
132 lower member actuator
133 upper member
134 upper member actuator
141 moving rail
142 holding block
143 presser block
144 actuator for presser
145 movement completion confirmation block
146 movement completion confirmation actuator
211 covered part
212 exposed core
221 fitting part (housing portion)
222 core wire crimped portion
223 insulation crimp part
311 axis
D13 longitudinal direction
D14 axial direction
D15 moving direction
D16 arrangement direction

What is claimed is:

1. A terminal insertion device of inserting at least a portion of a housing portion of a connector terminal crimped to an end of an electrical wire into a cylindrical terminal housing in a connector housing, wherein the connector terminal includes the housing portion, a core wire crimped portion to be crimped to an exposed core wire of the electrical wire located nearer a rear end side than the housing portion, and a cover crimped portion to be crimped to a cover portion adjacent to the exposed core wire located nearer the rear end side than the core wire crimped portion, and the connector housing includes a quadrangularly-grooved guide rail in communication with the terminal housing to guide the terminal end to enter into the terminal housing, the terminal insertion device comprising:
a terminal-side holding part configured to hold a portion of at least one of the electrical wire and the cover crimped portion in the connector terminal;
a housing moving part configured to hold the connector housing so that a longitudinal direction of the connector terminal and an axial direction of the terminal housing coincide with each other when the portion of at least one of the electrical wire and the connector terminal is held by the terminal-side holding part, and to slide the connector housing until the connector terminal is accommodated in the terminal housing along the longitudinal direction, and
a crimp holding part configured to set a posture of the housing portion about an axis by holding the core wire crimped portion so that the housing portion enters the guide rail in response to sliding of the connector housing, and retract to a position at which further slide movement is not hindered while releasing the core wire crimped portion when the housing moving part slides the connector housing until the housing portion enters at least the guide rail.

2. The terminal insertion device according to claim 1, further comprising:
an electrical wire holding part configured to hold the electric wire at a holding position opposite to the housing moving part as viewed from the terminal-side holding part, wherein
the connector terminal is a female terminal in which the housing portion is formed in a quadrangular cylindrical shape,
the terminal housing accommodates the connector terminal in a non-rotatable manner around the axis, the terminal-side holding part is configured, when the housing moving part slides the connector housing until a terminal end of the connector terminal enters the terminal housing, to retract to a position at which further slide movement is not hindered while releasing the portion of at least one of the electrical wire and the connector terminal, the housing moving part is configured to slide the connector housing until the terminal end enters the terminal housing, and further slide the connector housing until the housing portion is completely accommodated with the electric wire being held by the electrical wire holding part after the terminal-side holding part retracts.

3. A terminal insertion method of inserting at least a portion of a housing portion of a connector terminal crimped to an end of an electrical wire into a cylindrical terminal housing in a connector housing, wherein the connector terminal includes the housing portion, a core wire crimped portion to be crimped to an exposed core wire of the electrical wire located nearer a rear end side than the housing portion, and a cover crimped portion to be crimped to a cover portion adjacent to the exposed core wire located nearer the rear end side than the core wire crimped portion, and the connector housing includes a quadrangularly-grooved guide rail in communication with the terminal housing to guide the terminal end to enter into the terminal housing, the method comprising the steps of:
terminal-side holding step of holding a portion of at least one of the electrical wire and the cover crimped portion in the connector terminal,
housing moving step of holding the connector housing such that a longitudinal direction of the connector terminal and an axial direction of the terminal housing coincide with each other when the portion of at least one of the electrical wire and the connector terminal is held in the terminal-side holding step, and sliding the connector housing until the connector terminal is accommodated in the terminal housing along the longitudinal direction, and
setting and retracting step of while setting a posture of the housing portion about an axis by holding the core wire crimped portion so that the housing portion enters the guide rail in response to sliding of the connector housing, retracting to a position at which further slide movement is not hindered while releasing the core wire crimped portion when the housing moving part slides the connector housing until the housing portion enters at least the guide rail.
